(19) United States
(12) Patent Application Publication
(10) Pub. No.: US 2020/0141215 A1
(43) Pub. Date: May 7, 2020

(54) EVALUATING FAR FIELD FRACTURE COMPLEXITY AND OPTIMIZING FRACTURE DESIGN IN MULTI-WELL PAD DEVELOPMENT

(71) Applicant: Baker Hughes, a GE company, LLC, Houston, TX (US)

(72) Inventors: James B. Crews, Willis, TX (US); Robert Samuel Hurt, Tomball, TX (US)

(73) Assignee: Baker Hughes, a GE company, LLC, Houston, TX (US)

(21) Appl. No.: 16/736,396

(22) Filed: Jan. 7, 2020

Related U.S. Application Data
(62) Division of application No. 15/594,202, filed on May 12, 2017, now abandoned.
Application No. 15/594,202 is a continuation-in-part of application No. 15/147,449, filed on May 5, 2016, now Pat. No. 10,253,598.
(60) Provisional application No. 62/158,161, filed on May 7, 2015.

(51) Int. Cl. E21B 43/17; G01V 1/28; E21B 41/00

(52) U.S. Cl. CPC E21B 43/17; E21B 41/0035; G01V 1/288

(57) ABSTRACT

A method for evaluating and optimizing complex fractures, in one non-limiting example far-field complex fractures, in subterranean shale reservoirs significantly simplifies how to generate far-field fractures and their treatment designs to increase or optimize complexity. The process gives information on how much complexity is generated for a given reservoir versus distance from the wellbore under known fracturing parameters, such as rate, volume and viscosity. The method allows the evaluation of the performance of diversion materials and processes by determining the amount of fracture volume generated off of primary fractures, including far-field secondary fracture volumes. The methodology utilizes fracture hit times, volumes, pressures and similar parameters from injecting fracturing fluid from a first primary lateral wellbore to create fractures and record fracture hit times, pressures and volumes from a diagnostic lateral wellbore in the same interval.

### CROSS-REFERENCE TO RELATED APPLICATION

This application is a divisional patent application from U.S. Ser. No. 15/594,202 filed May 12, 2017, which is a continuation-in-part patent application of U.S. Ser. No. 15/147,449 filed May 5, 2016, issued Apr. 9, 2019 as U.S. Pat. No. 10,253,598, which in turn claims the benefit of U.S. Provisional Patent Application Ser. No. 62/158,161 filed May 7, 2015, all of which are incorporated herein by reference in their entireties.

### TECHNICAL FIELD

The present invention relates to methods of obtaining information about subterranean formations and features therein using multiple wellbores, and more particularly relates, in one non-limiting embodiment, to methods of obtaining information about subterranean shale formations and features thereof using multiple wellbores comprising a first lateral wellbore and at least one diagnostic lateral wellbore adjacent thereto to induce fracture complexity in a region away from the wellbore.

### TECHNICAL BACKGROUND

It is well known that hydrocarbons (e.g. crude oil and natural gas) are recovered from subterranean formations by drilling a wellbore into the subterranean reservoirs where the hydrocarbons reside, and using the natural pressure of the hydrocarbon or other lift mechanism such as pumping, gas lift, electric submersible pumps (ESP) or another mechanism or principle to produce the hydrocarbons from the reservoir. Conventionally most hydrocarbon production is accomplished using a single wellbore. However, techniques have been developed using multiple wellbores, such as the secondary recovery technique of water flooding, where water is injected into the reservoir to displace oil. The water from injection wells physically sweeps the displaced oil toward adjacent production wells. Potential problems associated with water flooding techniques include inefficient recovery due to variable permeability or similar conditions affecting fluid transport within the reservoir. Early breakthrough is a phenomenon that may cause production and surface processing problems.

Hydraulic fracturing is the fracturing of subterranean rock by a pressurized liquid, which is typically water mixed with a proppant (often sand) and chemicals. The fracturing fluid is injected at high pressure into a wellbore to create, in shale for example, a network of fractures in the deep rock formations to increase permeability therein and allow hydrocarbons to migrate to the well. When the hydraulic pressure is removed from the well, the proppants, e.g. sand, aluminum oxide, etc., hold open the fractures once fracture closure occurs. In one non-limiting embodiment chemicals are added to increase the fluid flow and reduce friction to give “slickwater” which may be used as a lower-friction-pressure placement fluid. Alternatively in different non-restricting versions, the viscosity of the fracturing fluid is increased by the addition of polymers, such as crosslinked or uncrosslinked polysaccharides (e.g. guar gum) or by the addition of viscoelastic surfactants (VES).

Recently the combination of directional drilling and hydraulic fracturing has made it economically possible to produce oil and gas from new and previously unexploited ultra-low permeability hydrocarbon bearing lithologies (such as shale) by placing the wellbore laterally so that more of the wellbore, and the series of hydraulic fracturing networks extending therefrom, is present in the production zone permitting more production of hydrocarbons as compared with a vertically oriented well that occupies a relatively small amount of the production zone. “Laterally” is defined herein as a deviated wellbore away from a more conventional vertical wellbore by directional drilling so that the wellbore can follow the oil-bearing strata that are oriented in a non-vertical plane or configuration. In one non-limiting embodiment, a lateral wellbore is any non-vertical wellbore. In another non-limiting embodiment, a lateral wellbore is defined as any wellbore that is at an inclination angle from vertical ranging from about 45° to about 135°. It will be understood that all wellbores begin with a vertically directed hole into the earth, which is then deviated from vertical by directional drilling such as by using whipstocks, downhole motors and the like. A wellbore that begins vertically and then is diverted into a generally horizontal direction may be said to have a “heel” at the curve or turn where the wellbore changes direction and a “toe” where the wellbore terminates at the end of the lateral or deviated wellbore portion. The “sweet-spot” of the hydrocarbon bearing reservoir is an informal term for a desirable target location or area within an unconventional reservoir or play that represents the best production or potential production. The combination of directional drilling and hydraulic fracturing has led to the so-called “fracking boom” of rapidly expanding oil and gas extraction in the US beginning in about 2003.

Improvements are always needed in the driller's ability to produce more complex fracture networks when the shale is fractured. Improvements are also needed in the amount of and quality of knowledge about fracture networks, the parameters that control fracture geometry and reservoir production, how reservoirs react to refracturing techniques, and the like.

### SUMMARY

There is provided in one non-limiting embodiment a method for evaluating and optimizing fracture complexity and fracture design for lateral wellbores when fracturing a subterranean formation having a plurality of intervals in a sequence along a first primary lateral wellbore and at least one diagnostic lateral wellbore adjacent the first primary lateral wellbore. The method is also applicable, but not necessarily limited to, far field fracture complexity. The method includes a) fracturing a first interval in the sequence from the first primary lateral wellbore by injecting fracturing fluid from the first primary lateral wellbore to create fractures, b) recording fracture hit times, pressures and volumes from the diagnostic lateral in the first interval, c) inducing fracture closure in the first interval, d) repeating steps a) through c) for at least a subsequent interval, and e) devising a fracturing treatment design for the subterranean formation to optimize fracture complexity for subsequent lateral wellbores using the recorded fracture hit times, pressures and volumes.

There is additionally provided in a non-limiting embodiment a method for evaluating and optimizing fracture complexity when fracturing a subterranean formation having a plurality of intervals in sequence along a first primary lateral wellbore and at least one diagnostic lateral wellbore adjacent the first primary lateral wellbore. The method includes a) fracturing a first interval in the sequence from the first primary lateral wellbore with an indicator by injecting fracturing fluid from the first primary lateral wellbore to create fractures, b) recording fracture hit times, pressures and volumes from the diagnostic lateral in the first interval, c) inducing fracture closure in the first interval, d) repeating steps a) through c) for at least a subsequent interval, e) determining the amount and size of produced indicator to devise a tuned diverter design for placing a diverter in at least a second interval, f) determining characteristics of a complexity storage modulus for at least the first interval and a third interval on either side of the second interval, g) fracturing the second interval with the tuned diverter design, h) evaluating a diverter induced change in complexity storage modulus and analyzing produced materials from the second interval, i) from the information obtained in steps g) and h) optimizing the tuned diverter design. The indicator may comprise, but not necessarily be limited to, a proppant including but not necessarily limited to an ultra-lightweight proppant (ULWP), a tracer including but not necessarily limited to chemical tracers, fluorescent tracers, dye tracers, and the like.

### BRIEF DESCRIPTION OF THE DRAWINGS

FIG. 1 is a schematic, plan view of a sequence of shale intervals in a subsurface volume illustrating along a first primary lateral wellbore and a diagnostic lateral wellbore and how fracture hit times are measured;

FIG. 2 is a schematic, plan view of a sequence of shale intervals in a subsurface volume illustrating along a first primary lateral wellbore and an alternatively positioned diagnostic lateral wellbore also illustrating how fracture hit times are measured;

FIG. 3 graph of pressure as a function of time schematically illustrating fracture hit times for five fracture intervals;

FIG. 4 is a schematic, plan sectional view of a subsurface volume illustrating a first primary lateral wellbore and a diagnostic lateral wellbore in a different non-limiting position illustrating how injection tests determine hydraulic fracture/natural fracture (HF/NF) interactions;

FIG. 5 is a schematic graph of complexity volumes for the data intervals in FIG. 4, where the ratio of volumes is the complexity storage modulus, and the volume/time is plotted as a function of the interval; and

FIG. 6 is a top down, plan sectional view of a subsurface volume illustrating a lateral field configuration with an angled data collection interval.

It will be appreciated that the drawings are schematic and should be understood as not necessarily to scale or proportion, and that certain features are exaggerated for emphasis. Furthermore, the methods and configurations described herein should not be limited to particular embodiments illustrated in the drawings.

### DETAILED DESCRIPTION

Obtaining information from subterranean formations using a single wellbore or “mono-bore” approach, even implementing directional drilling and hydraulic fracturing, has a number of limitations, including, but not necessarily limited to, only obtaining information about the immediate environment of the single wellbore and the single wellbore wall.

It has been discovered that the use of at least one diagnostic lateral wellbore adjacent or proximate to a first primary lateral wellbore and at least one adjacent diagnostic lateral wellbore may provide a wealth of information about the first primary lateral wellbore and diagnostic lateral wellbore and/or the subsurface volume surrounding these wellbores. As defined herein, in one non-limiting embodiment, primary lateral wellbores are wellbores drilled for performing primary diagnostic-based fracturing treatments within one or more fracturing interval locations along the length of the lateral, for understanding and improving how best to stimulate and produce geo-specific shale reservoirs, and may include eventual production of hydrocarbons from the reservoir into which they are placed for many types of fracturing treatments and/or fracture treatment conditions and how best to influence reservoir hydrocarbon production.

As also defined herein, in one non-limiting embodiment, “near-wellbore” is within 20 feet (6 m) of the wellbore, alternatively within 60 feet (18 m) of the wellbore. In one non-limiting embodiment, “far-field” is defined as greater than 60 feet (15 m) from the wellbore; alternatively as 100 feet (30 m) or greater from the wellbore.

A further limitation with conventional mono-bore approaches is that after a fracturing treatment of shale formation in a subsurface volume bearing a hydrocarbon reservoir it is difficult to know what actually happened within the reservoir. It will be appreciated that there are many different types of complex fracture networks and that in fact along the same lateral wellbore, each fracture network can be different from the next, even comparing the fracture networks in adjacent fracture intervals.

By “fracture networks” or “complex fracture networks” is meant that a series and/or distribution of multiple fractures are generated hydraulically that provide fluid flow pathways and communication through a shale reservoir, e.g. ultra-low permeability shale reservoir, or other reservoir type to the wellbore or wellbores, in contrast to simply forming a single fracture and/or a few fractures within the shale reservoir that connect to the wellbore. It is much more desirable to create fracture complexity both in the near-wellbore region and far-field regions than to have a single fracture or a few large fractures. The more surface area of the shale reservoir that is exposed and connected to a wellbore or wellbores (i.e. complex fracture network) through hydraulic fracturing the better, that is, close to the wellbore (near wellbore complex fractures) as well as far from the wellbore (far-field complex fractures). In most cases, when hydraulically fracturing, far-field complex fracture networks are more difficult to create, and as compared to near wellbore complex fracture, typically have reduced number of fractures, surface area, and less flow path systems in further relation to the wellbore.

The methods described herein will help diagnose, analyze and interpret these complex fracture networks, as well as to obtain more accurate information about other subsurface volume structures including the wellbore wall and earth and rock around the wellbore. Parameters that can be determined using one or more of the methods described herein include, but are not necessarily limited to, parameters that control fracture geometry in geo-specific shales, and parameters that control reservoir production for geo-specific shales, which in turn include fracture hit times, fracture pressures, and/or fracture volumes. These methods may also be used for quicker location of sweet-spot horizons in reservoirs (defined herein as the strata within a shale interval that represents the best production or potential production of hydrocarbons) and how produced reservoirs react to refracturing (refrac) techniques. In other words, accuracy in targeting and fracturing sweet-spot horizons may be improved.

It has been discovered that many of these problems and limitations may be overcome using multiple lateral wellbores—beyond conventional “mono-bore” approaches. The use of multiple lateral wellbores can provide knowledge about processes including, but not necessarily limited to, fracture network closure, fracture network cleanup, optimized fracture treatment design and production enhancement and/or remediation treatments, multi-lateral refracturing (“refrac”) treatments, and combinations of these. Further, a wellbore treatment that can be conducted, improved or optimized with the methods described herein may include, but not necessarily be limited to, hydraulically fracturing the subsurface volume, closing a fracture network, cleaning up a fracture network, placing proppant in a fracture network, acid fracturing the subsurface volume, diverting a composition injected into a wellbore, and/or refracturing the subsurface volume.

The method includes combinations of one or more diagnostic lateral wellbores adjacent and/or proximate to one or more primary lateral wellbores for fracture imaging and other data collection during and after diagnostic treatments to use the data to devise a fracturing treatment design for other lateral wells in the same or similar subterranean formation. The method can, through optimized, close proximity to ultra-close proximity of diagnostic instruments to the fractured interval (i.e. solely for improving imaging resolution or other data collection of stimulated interval) image shale complex fracture networks in real-time; that is during the different stages of hydraulic fracture treatment to a rock volume. By placement of these one or more diagnostic lateral wellbores in close proximity to ultra-close proximity for high to ultra-high imaging resolution of the fracture interval, these methods help observe and thereby learn and understand how treatment parameters control complex fracture network growth and geometry in geo-specific shales. As defined herein, moderately-close proximity is defined as between 300 to 600 feet (91 meters to 183 meters) from the primary lateral, close proximity is defined as between 200 feet to less than 300 feet (61 and less than 91 meters) from the primary lateral, very-close proximity is defined as between 100 and less than 200 feet (30 and less than 61 meters) from the primary lateral, and ultra-close proximity is defined as between 0 feet to less than 100 feet (0 and less than 30 meters) from the primary hydraulic fracture and/or fracture plane generated during a primary diagnostic treatment. The use of diagnostic laterals and their proximity placements herein is to obtain the highest imaging resolution possible for gathering as much information about physical changes to the immediate reservoir rock volume, during diagnostic hydraulic fracturing processes, during cleanup of the treatment fluid, during diagnostic well induced cleanup of the fracture network and/or interval (i.e. assisted cleanup to understand the importance of degree of treatment fluid cleanup to production), importance of fracture network closure processes, during production optimization treatments originating from the primary and/or diagnostic lateral, and/or parameters that improve fracture network growth and treatment fluid recovery for future fracture treatment designs and refrac treatments.

More specifically, the use of diagnostic lateral wellbores can improve fracture imaging and diagnostic treatments, and therefore improve fracturing treatment design. Fracture imaging includes, but is not limited to, imaging hydraulic fracture generation, mapping fracture network cleanup, production fluid mapping, imaging fractures during refracs, and wildcat field development data, and the like. Diagnostic treatments include, but are not necessarily limited to, diagnostic frac treatments, diagnostic closure experiments, improving fracture network cleanup, optimizing production treatments, and diagnostic refrac treatments. Diagnostic information that may be generated includes, but is not necessarily limited to, parameters that control fracture geometry in geo-specific shales, parameters that control reservoir production for geo-specific shales, parameters for quicker location of sweet-spot horizons in reservoirs, parameters and materials and chemical processes for more effective treatment fluid recovery and resultant fracture network permeability and/or conductivity, and/or determining how produced reservoirs react to refracturing techniques. These parameters include, but are not necessarily limited to fracture hit times, pressures, and volumes, as will be described below.

The ability to understand and control parameters to induce secondary fractures branching from planar fractures in shales is very complex. The ability to utilize diversion materials or particles to induce far-field secondary fractures is also very highly complex. The foremost parameter which controls secondary fracture generation is the reservoir anisotropy. The higher the anisotropy stress present the less likely secondary fractures will be induced by fracturing parameters and/or with use of diversion materials. A process is presented for how to understand how much far-field fracture complexity can be created. The methodology utilizes “fracture hit time” and similar parameters from offset coiled tubing configured laterals and frac processes. What can be learned through the “fracture hit time” process can generate information for how to design reservoir specific frac designs, which includes the quantitative amount of far-field complex fracture network volume for given frac process parameters, rather than using trial and error guesses during multi-interval fracture completion of laterals. The process can be performed by using coiled tubing in two offset laterals, as shown in the Figures, which are described more completely below. Optional use of coiled tubing can help provide isolation so that one knows where the fracturing fluid is injected from a first primary lateral wellbore and where on the diagnostic lateral wellbore the fracturing fluid is received. Isolating the injection point and isolating the receiving point may be accomplished in other ways, such as through the use of valves, packers, and other known devices and methods. Knowing the travel of the signal paths from the injection point to the receiving point helps determine the fracture hit times.

Measurement of pressure, volume, and viscosity downhole at aligned perforations can generate “fracture hit time” and other important information of fracture propagation speed, amount of non-planar fracture volume (i.e. fracture complexity), and the like. The pressure-volume and the like information will allow the rest of the lateral and/or series of laterals in the lateral field to be completed and fractured under more clear and precise fracturing parameters, such as the number of perforation clusters, the number of perforations per cluster, the orientations of perforations, the perforation cluster spacing, the amount of pad volume to use, the type and amount of proppant, the staged treatment volumes, pump rates, the effectiveness of planar fracture diverters and diversion methods, the transport properties of far-field proppants, and the like. This process could become a complexity calibration test for designing factory fracs for lateral fields.

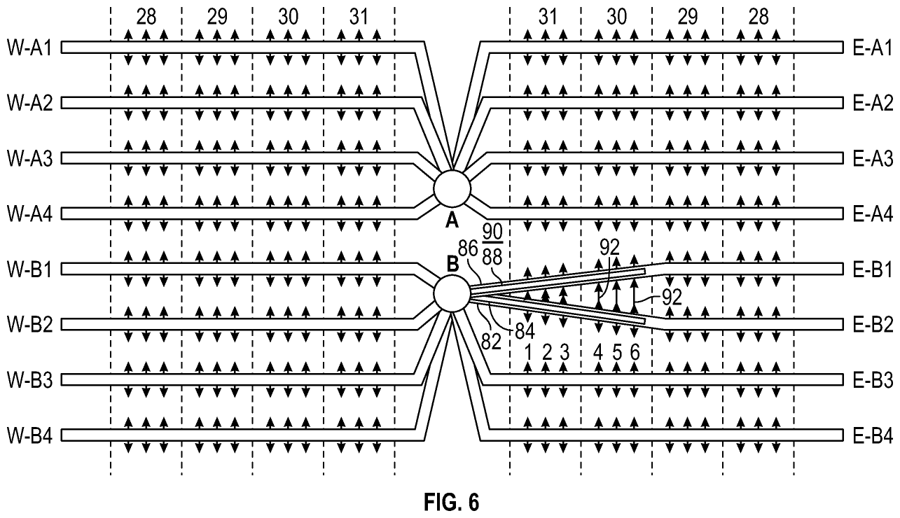

By “factory fracs” is meant a standard fracturing design, meaning that once the desired near field and far field fracture complexity information for a certain job design is determined (e.g. rate, pressure, usage of diverter, fluid, proppant, etc.), it can be executed for all laterals on the same pad; for instance, see FIG. 6.

In new field evaluations, the use of one or more diagnostic lateral wellbores can assist in locating economical horizons. In early field learning, these multiple diagnostic lateral wellbores can help in identifying and landing in sweet-spot horizons; help determine the primary lateral wellbore location and length, help determine diagnostic lateral wellbore type, placement and purposes; map fracture treatments (design parameters vs. fracture network complexity); help design the number of fracture intervals, improve the basic frac treatment design, investigate aggressive frac processes, and improve fracture network cleanup and treatment cleanup techniques. In main field completions, the use of one or more lateral diagnostic wellbores can assist in optimizing frac treatments and cleanup designs. In mid- to late well production, multiple lateral wellbores can help with production fluid mapping, evaluation of production optimization treatments and the applications of treating chemicals. The use of one or more diagnostic lateral wellbore can help optimize fracturing treatment design for geo-specific shale reservoirs, that is, shale formations at a geographically specific location. It is important to the shale completion industry to learn more specifically and much more quickly how each shale reservoir should be hydraulically fractured for optimum fracture complexity, surface area generated, amount and distribution of fracture conductivity, determination of high permeability and/or hydrocarbon sweet-spot horizons and the like. Presented herein is a methodology for how to measure the interactions of hydraulic fractures with the natural fractures in the shale and/or weak stress planes within geo-specific reservoirs. The data for designing reservoir-specific frac treatment designs is generated by controlled-parameter injection tests between two lateral wellbores during the initial field development stage.

Learning and diagnosing shale hydraulic fracturing includes one or more of at least seven areas: (1) fracture geometry, (2) fracture diversion and fracture complexity, (3) fracture conductivity, (4) fracture closure, (5) fracture cleanup, (6) dual-wellbore and multi-wellbore improvements (going beyond mono-bore stimulation and production), and (7) sweet-spots (the parameters controlling access to and stimulation of sweet-spot horizons). (1) Fracture geometry includes, but is not necessarily limited to (a) effects of fluid parameters, (b) effects of treatment parameters, (c) effects of reservoir parameters, and (d) how to detect sweet-spot horizons. (2) Fracture diversion and fracture complexity includes, but is not necessarily limited to (a) how to control fractures in specific locations, (b) effects of various treatment fluids, (c) effects of materials, concentrations, and staging, (d) effects of pump rate, and (e) effects of reservoir parameters. (3) Fracture conductivity includes, but is not necessarily limited to (a) proppant transport and distribution, (b) complex fracture network conductivity, (c) primary fracture plane conductivity, and (d) transitional conductivity versus choke points. (4) Fracture closure includes, but is not necessarily limited to (a) primary fractures, (b) complex fracture networks, (c) effects on fracture conductivity, and (d) optimum location(s) for inducing closure. (5) Fracture cleanup includes, but is not necessarily limited to (a) effects of natural cleanup methods, (b) effects of induced cleanup methods, (c) importance of complex fracture network cleanup, (d) importance of primary fracture network cleanup, (e) importance of distance and conductivity to perforations, and (f) effects on sweet-spot productivity.

In another non-limiting embodiment, the process of establishing communication between adjacent lateral production wellbores, for improving methods to induce fracture network closure, for cleaning up fracture networks, injecting production chemicals, performing refracs, and the time between drilling primary laterals and assisting laterals can be several years, and after primary laterals or other lateral wellbores have been produced for several years. In other words, acreage and a field of lateral production wellbores may already exist where in-field drilling of additional lateral wellbores between or adjacent to existing lateral wellbores may be configured to diagnose the multi-lateral stimulation and production benefits. In one non-limiting example, the newer production lateral wellbores drilled may be labeled as “primary laterals” and the existing or older and already produced lateral wellbores as “assisting laterals”. The in-fill new lateral wellbores could then be multi-laterally stimulated with use of the existing production lateral wellbores, where the new lateral wellbore is first near-wellbore fractured followed by then generating a conductive primary fracture into the older laterals' fracture network and/or to or very near the older laterals' wellbores, followed by release of treatment pressure through the older lateral wellbores to induce closure of the new primary lateral fracture network, and then eventually the older lateral wellbores are used to supply energy and mass or cleanup fluid to clean-up the prior and/or the newly created fracture network, where the cleanup fluid and the residual treatment fluid is produced into the new primary lateral wellbore. By “in-fill” is meant a wellbore that is positioned between or next to pre-existing wellbores. In summary, the function of a lateral wellbore may (or may not) change over time, and/or the physical configuration of lateral and vertical wellbores, and their spatial relationships to each other may change over time as new wellbores are introduced.

The first drilling and producing conventional field lateral wellbores followed by later time in-fill lateral drilling may be advantageous for many reasons to the operator. The methods described here using diagnostic lateral wellbores can help diagnose factors including, but not necessarily limited to, (a) determining hydrocarbon production economics, (b) determining areas of the acreages and shale reservoir which may indicate having higher total hydrocarbon content, (c) lessons learned through different completion parameters (such as interval spacing, perforation spacing and density, and the like), (d) better indication of horizons of the shale interval that are the sweet spots, and the like, and these factors can play a role in a later in-fill drilling program that utilizes the bi-directional communication of laterals established between old and new lateral wellbores that are stimulated between the multiple lateral wellbores. In one non-limiting embodiment, all laterals, both old and new, can then be producing laterals. There can be a wide range of variables in how the old laterals and perforated intervals are utilized in respect to the newly drilled adjacent laterals.

In another non-limiting example, the older lateral wellbores may be refractured (refrac) followed by the new primary lateral stimulation process, where the re-stimulation includes a new in-fill completion process. In yet another non-limiting example, once the new lateral wellbore is stimulated and cleaned up through use of the older adjacent lateral wellbores, the older lateral wellbores can initially or later become the far-field complex fracture network in relation to the new primary lateral wellbore and its production characteristics. By using diagnostic lateral wellbores, the in-fill process may also, in another non-limiting example, provide a wide range of diagnostic information in drilling, stimulating, closing, cleanup and production of the new in-fill primary lateral wellbores. The diagnostic information may be different or similar as compared to all adjacent lateral wellbores being newly drilled and non-produced prior to stimulation, closure and cleanup process by lateral-to-lateral communication established in multi-lateral completions as described herein. The more complete and more accurate information about processes and events downhole can have considerable economic value about how to better improve stimulation and completions of shale reservoirs in general or in geo-specific areas.

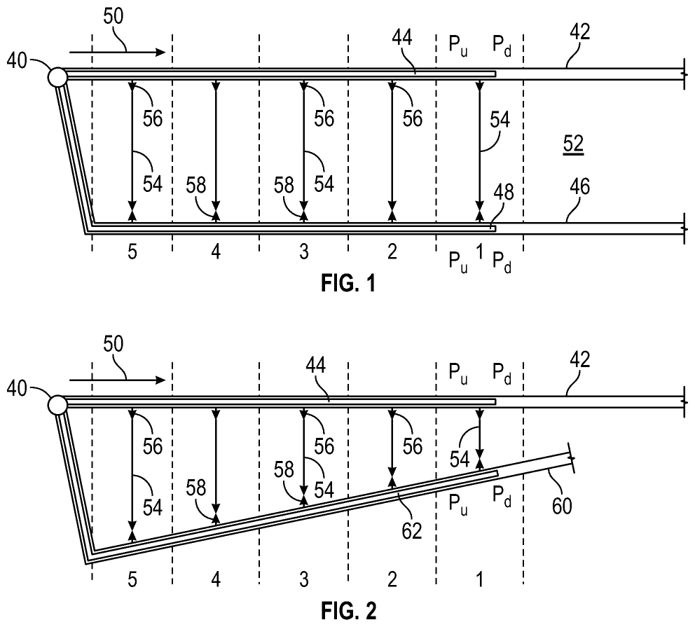

There are a multitude of suitable configurations for one or more diagnostic lateral wellbores in proximity to or adjacent to one or more primary lateral wellbores. A limited number are shown and described in U.S. Patent Application Publication No. 2016/0326859 A1 incorporated herein by reference in its entirety; please see FIGS. 2A through 31C, although others may be imagined. For instance, the first primary lateral wellbore and the adjacent diagnostic lateral wellbore may be side-by-side, one over the other, or in other relationships. It is not necessary that the primary lateral wellbore and the adjacent diagnostic lateral wellbore be in the same formation (although they may be) so long as signals, e.g. fracture hit times, can be picked up by the diagnostic lateral wellbore from the primary lateral wellbore. It should be noted that there should not be another, third wellbore between the primary lateral wellbore and the diagnostic lateral wellbore; in that case they would not be adjacent.

In non-limiting embodiments, when at least one diagnostic lateral wellbore is substantially adjacent to and/or proximate to at least one primary lateral wellbore, this is defined herein as within about 25 independently to about 2500 feet (about 7.6 independently to about 762 meters); in another non-limiting version from about 50 independently to about 2000 feet (about 15 independently to about 610 meters) of each other, alternatively within about 100 independently to about 1200 feet (about 30 independently to about 366 meters) of each other; and in another non-limiting version from about 200 independently to about 800 feet (about 61 independently to about 244 meters) of each other. “Substantially parallel” is defined herein as within 0 independently to about 8° of the same angle as each other; alternatively within from about 0° independently to about 5° of each other. That is, the adjacent lateral wellbores do not need to be precisely parallel to be considered substantially parallel. The term “independently” as used herein with respect to a range means that any lower threshold may be combined with any upper threshold to give a suitable alternative range. As will be explained and shown, however, the adjacent diagnostic lateral wellbore need not be parallel or even substantially parallel to the primary lateral wellbore and the subsurface volume that is being diagnosed.

Dual fracturing, or dual-injection of frac systems, is injection from two or three adjacent laterals where treatment fluid and fracture networks approach and eventually interact with each other. The injection rates, type of fluid, viscosity of fluid, and stop-start staging of fluid injection may vary from the adjacent wellbores, with parameters and conditions varied to gain diagnostic-based insight of how the reservoir properties and fracture networks may be geometrically controlled and the frac interval reservoir area may be more optimally stimulated. That is, the size, amount, distribution and the like of the hydraulic fractures and related propped and non-propped conductivity generated within the frac interval. This significantly differs from “mono-bore” fracture stimulation methodology for learning how to optimize reservoir stimulated rock volume and related hydrocarbon productivity from geo-specific shales.

There are a number of known imaging techniques that may be implemented in the methods and configurations for diagnosing subsurface volumes containing at least primary lateral wellbore, including, but not necessarily limited to the following.

A. R. Rahmani, et al. in “Crosswell Magnetic Sensing of Superparamagnetic Nanoparticles for Subsurface Applications,” SPE 166140, SPE Annual Technical Conference and Exhibition, New Orleans, La., USA, 30 Sep.-2 Oct. 2013 discloses that stable dispersions of superparamagnetic nanoparticles are capable of flowing through micron-size pores across long distances in a reservoir having modest retention in rock. These particles can change the magnetic permeability of a flooded region, and thus may be used to enhance images of the flood. Propagation of a “ferrofluid slug” in a subsurface volume through primary lateral wellbores may have its response monitored by a crosswell magnetic tomography system as described in this paper. This approach to monitoring fluid movement within a reservoir is built on established electromagnetic (EM) conductivity monitoring techniques.

U.S. Pat. No. 8,253,417 to Baker Hughes Incorporated, incorporated herein by reference in its entirety, discloses an electrolocation apparatus useful for determining at least one dimension of at least one geological feature of an earthen formation from a subterranean well bore which includes at least two electric current transmitting electrodes and at least two sensing electrodes disposed in the well bore. The electric current transmitting electrodes are configured to create an electric field and the sensing electrodes are configured to detect perturbations in the electric field created by at least one target object. This electrolocation apparatus and method can approximate or determine at least one dimension of geological features such as hydraulic fractures.

S. Basu, et al., in “A New Method for Fracture Diagnostics Using Low Frequency Electromagnetic Induction,” SPE 168606, SPE Hydraulic Fracturing Technology Conference, the Woodlands, Tex., USA, 4-6 Feb. 2014 discloses that at the time of the article, microseismic monitoring is widely used for fracture diagnosis. Since the method monitors the propagation of shear failure events, it is an indirect measure of the propped fracture geometry. The primary focus of the paper is in estimating the orientation and length of the “propped” fractures (in contrast to the created fractures), since this is the principal driver for well productivity. The paper presents a new Low Frequency Electromagnetic Induction (LFEI) method which has the potential to estimate not only the propped length, height and orientation of hydraulic fractures, but also the vertical distribution of proppant within the fracture. The proposed technique involves pumping electrically conductive proppant into the fracture and then using a specially built logging tool that measures the electromagnetic response of the formation. Results are presented for a proposed logging tool that consists of three sets of tri-directional transmitters and receivers at 6, 30 and 60 feet spacing, respectively (1.8, 9.1 and 18 m, respectively). The solution of Maxwell's equation shows that it is possible to use the tool to determine both the orientation and the length of the fracture by detecting the location of these particles in the formation after hydraulic fracturing. Results for extensive sensitivity analysis are presented to show the effect of different propped lengths, height and orientation of planar fractures in a shale formation. Multiple numerical simulations, using a leading edge electromagnetic simulator (FEKO), indicate that fractures up to 250 feet (76 m) in length, 0.2 inches (0.5 cm) wide and with a 45° of inclination may be detected and mapped with respect to the wellbore.

The methods and configurations of primary lateral wellbores and diagnostic lateral wellbores may take advantage of microseismic fracture mapping. For instance, R. Downie, et al. in “Utilization of Microseismic Event Source Parameters for the Calibration of Complex Hydraulic Fracture Models,” SPE 163873, SPE Hydraulic Fracturing Technology Conference, the Woodlands, Tex., USA, 4-6 Feb. 2014, notes that observations of microseismic events detected during hydraulic fracturing treatments have provided an incentive to develop complex fracture models. Calibration of these models may be difficult when only the locations and times of the microseismic events are used. Incorporating the microseismic event source parameters into the model calibration workflow reveals changes in fracture behavior that are not easily visualized and provides additional guidance to the selection of modeling parameters. Microseismic events occur when deformation of the reservoir and surrounding formations produces seismic waveforms. Hodogram analysis and travel-time of the recorded waveforms are used to locate the microseismic event sources, while the amplitudes and polarities of the waveforms provide information about the deformation that has occurred. The geophysical property that is derived from the wave amplitudes is known as the seismic moment and is related to the area and displacement of the failure.

The relationship between seismic moment values and the deformations that produced microseismic events may be applied to engineering evaluations to identify variations in microseismic response. Use of this source parameter supplements commonly used visualizations of microseismic response where microseismic activity has been mapped. Mapping of the seismic moment distributions in a three-dimensional viewer provides insights into fracture behavior that can be used to calibrate complex hydraulic fracture models. This is done through an integrated software package that facilitates comparisons of the microseismic evaluation and complex fracture modeling outputs seamlessly. Changes to the complex fracture model inputs can be evaluated easily and quickly to determine if the fracture modeling correlates well with the measured microseismic responses. Production evaluation, history-matching and forward-modeling to test different completion and stimulation design scenarios can be undertake with improved confidence sing the calibrated fracture model. The complex fracture models of SPE 163873 may be improved by using the methods and configurations of at least one primary lateral wellbore adjacent at least one diagnostic lateral wellbore described herein.

The methods and configurations of at least one primary lateral wellbore adjacent at least one diagnostic lateral wellbore which are described herein may also find utility in induced acoustic wave fracture mapping or micro-imaging. “Micro-imaging” is defined herein as image data collected on the scale of a single fracture interval. This technique may use low-frequency high energy (LFHE) (also called low-frequency high intensity or LFHI) acoustic generators in one or more diagnostic lateral wellbore and an array of low-frequency sensors in one or more primary lateral wellbore. The use of sequential or alternate pulse, duration and frequency sweeps of acoustic generator signals (wave propagations) in the high to ultra-high resolution generator-rock-sensor configurations described herein provide greater data clarity and/or degree of resolution for real-time hydraulic fracture generation mapping during fracture treatments, and may give 2D and/or 3D graphic displays of complex fracture networks. The high resolution mapping of complex fracture network generation should provide empirical data of hydraulic fracture-natural fracture interactions for calibrating fracture and reservoir models for improving geo-specific shale stimulation and production.

One non-limiting way of how this may be accomplished is described by A. Bolshakov, et al. in “Deep Fracture Imaging Around the Wellbore Using Dipole Acoustic Logging,” SPE 146769, SPE Annual Technical Conference and Exhibition, Denver, Colo., US, 30 Oct.-3 Nov. 2011, which discloses that characterizing fractures in reservoir rocks is important because they provide critical conduits for hydrocarbon production from the reservoir into the wellbore. The standard method uses shallow borehole imaging services, both acoustic and resistivity, which essentially look at the intersection of the fractures at the borehole wall. Cross-dipole technology has extended the depth of evaluation some 2-4 ft (0.6-1.2 m) around the borehole by measuring the fractureinduced azimuthal shear-wave anisotropy. A recently developed shear-wave reflection imaging technique provides a method for fracture characterization in a much larger volume around the borehole with a radial extent of approximately 60 ft (18.3 m). This technique uses a dipole acoustic tool to generate shear waves that radiate away from the borehole and strike a fracture surface. The tool also records the shear reflection from the fracture. The shear-wave reflection, particularly the SH waves polarizing parallel to the fracture surface, is especially sensitive to open fractures, enabling the fractures to be imaged using this dipole-shear reflection data. (SH waves are shear waves that are polarized so that its particle motion and direction of propagation are contained in a horizontal plane.) The authors used case examples to demonstrate the effectiveness of this shear-wave imaging technology that maps fractures up to 60 ft (18.3 m) away and even detects fractures that do not intercept the borehole.

Working with transit time angles of the signals from each acoustic generator to each sensor can indicate fracture size, growth, branching and horizontal network geometry over time. The acoustic waves generated by LFHE acoustic generators will have relatively short distances to travel through the shale interval (as contrasted with conventional approaches using only adjacent substantially vertical wellbores) so that the signal type, intensity, amount of distortion and the like will encounter less rock minerals, pores, fluids, natural fractures and the like and thus provide improved information quality, particularly with the control of the intensity, duration, pulse timing, and the like, of the acoustic wave generators for acquiring baseline and changes to the reservoir and hydraulic fractures over time. In other words, the LHFE acoustic generators can be positioned in various diagnostic lateral wellbores with low frequency sensors in adjacent lateral wellbores to give better sampling measurements of the speed, reflection, refraction and the like of acoustic waves for better understanding of the localized shale interval properties and characteristics. The configurations of wellbores and methods described herein will also employ imaging technology that can measure how fractures propagate in specific shales, i.e. how they differ from one shale to another for a given set of treatment parameters. Shale reservoirs in general have differing physical, chemical and mechanical characteristics. How hydraulic fractures are generated and propagated in one shale reservoir to another will differ geographically, even under the same given set of hydraulic fracturing treatment parameters. Thus, the knowledge gained using the configurations and methods described herein can be important to learn how each shale reservoir should be hydraulically fractured for optimum fracture complexity, surface area generated, number of propped fractures, distribution of proppant, better understanding of fracture network conductivity generated, how to determine the select areas of the reservoir that show higher permeability and related criteria for determining the location of hydrocarbon sweet-spot horizons, and the like.

Each acoustic generator can be detected by multiple acoustic sensors, and as one non-limiting example, each acoustic generator is pulsed in intensity, duration, frequency, and time-stamped in sequential series (such as pulsation of generator 1, then generator 2, then generator 3, etc.) for data collected by acoustic sensors for pretreatment (i.e. baseline), during the treatment, and post treatment for characterizing, including, over time, dynamic growth of hydraulic fractures and related fracture networks, and rock stress alterations within an interval for determining and understanding how geo-specific shales respond to select treatment parameters and processes. To date, no diagnostic methodology for shale horizontal completions can provide this type and quality of information, as described in this non-limiting example of acoustic transmission, collection, and processing during and after diagnostic-based treatments. The degree of signal resolution within the treated interval is very important to obtaining data that can provide 2D and/or 3D visualization of developed hydraulic fracture networks, and the data needed in order to calibrate fracture models to have predictive skill for other treatments in the geo-specific shale area, that is, considerable acquired understanding (substantially increased learning rate) about how to develop optimized geometric fracture networks in geo-specific shales compared to past trial and error methodology of slow learning curve and sometimes years of extended treatment cost investment before learning how to properly stimulate and complete the targeted reservoir. One non-limiting example of elaborate investment costs and a significantly slow learning curve is recognized by the type of fracture treatment designs (materials, volumes, and processes) utilized in the Eagle Ford shale in 2008 versus in 2010 versus in 2014.

With respect to wildcat wells used to locate shale sweet-spots in new geologic or geo-specific shale plays, a significant amount of work and expense is put forth to find where and how to complete the shale interval with best success for economic return on investment (ROI). Most new play operators need to drill, stimulate and produce well over ten lateral wells to learn the minimum basics of shale geographic characteristics and suitable stimulation methods for best achieving an economic shale play. For this reason, operators need to acquire a suite of information in their initial field evaluation and development phases. Discussed herein are methods to help operators obtain important reservoir and stimulation technique information in a shorter period of time, which also reduces risks in knowing field and interval production potential. Diagnostic lateral wellbores can be used with imaging techniques and diagnostic-based treatments to generate important drilling and completion information for operators evaluating a new geo-specific shale play. For example, when drilling a vertical well to then further drill evaluation lateral wellbores, methods and techniques are proposed where the evaluation laterals do not need to be as long in length, and where one or more diagnostic lateral wellbores are drilled in various configurations adjacent to primary laterals for the purpose of acquiring important information at a faster rate about the reservoir interval and effectiveness of fracturing treatment parameters to generate complex fracture networks, sweet-spot horizon determination, requirements for fracture network cleanup, additional diagnostic information on lateral and vertical heterogeneity of shale rock lithology, petrophysical properties, geomechanical properties, natural fissure properties, hydraulic fracture-natural fracture interactions, methods to optimize natural fracture dilation and extension, best geo-specific practices for acquiring near-wellbore and far-field complex fracture networks, best geo-specific practices for selection and use of proppants for achieving transitional nano-to-micro-to-milli-to-macro darcy conductivity versus abrupt nano-to- and/or micro-to-macro darcy conductivity within the complex fracture network, and the like.

It should be appreciated that the methods and configurations of at least one diagnostic lateral wellbore with at least one primary lateral wellbore may be used to evaluate stress shadow effects on fracture propagation direction and complexity. A “stress shadow” may be defined as a region or area on either side of a primary lateral wellbore formed by pressure injection. This stresses the rock in a lateral direction to provide more control in fracturing the shale. For bi-direction fracturing treatments, there is provided a number of control methods of region, timing, interaction, and the like, stress shadow utility and/or control options. In one non-limiting embodiment, the fracturing from the primary lateral wellbore may be initiated first and then stopped, followed by pumping from a diagnostic lateral wellbore and/or a parallel assisting lateral wellbores in one or more cycles, rather than simultaneously. In another non-limiting embodiment this kind of stop/start-low viscosity/high viscosity staged diversion process may be used to create complex fractures. That is, pumping a relatively low viscosity fracturing fluid, stopping the pressure, then pumping a relatively high viscosity fracturing fluid may be used alternatingly or in cycles to create complex fracture networks. Imaging and/or diagnostic devices can be arranged to capture the directions, propagations, and complexity of hydraulic fractures during the fracturing treatment, from only the primary lateral wellbore or by bi-directional fracturing treatments, in contrast to prior fracturing treatments where the fracture pressure and rock stresses have been retained. The diagnostic method may be used to steer the fracturing treatment away from a neighboring interval that might have retained fracture pressure.

One simple technique to evaluate stress shadowing is as follows: a) with two isolated frac intervals, perform a frac treatment on one and retain the treatment pressure; follow then by fracturing the adjacent (e.g. the left side) interval and image the fracture propagation and complexity; b) do the same as at a) above, but follow the first frac treatment with a frac treatment to the other side (e.g. the right side), and image the fracture propagation and complexity. Compare the a) and b) fracture geometry to see if the stress shadow causes fracture propagation to curve or deviate away. Other, more complex techniques can be performed including, but not necessarily limited to, pressurizing a diagnostic lateral wellbore in the frac interval parallel to the primary lateral wellbore to determine how front-placement stress shadow influences fracture growth, direction and complexity.

In another non-limiting embodiment, at least one diagnostic lateral wellbore in close proximity to hydraulic fractures or extending from at least one primary lateral wellbore along the fracture plane can help determine ideal locations for high resolution use of several imaging devices and techniques including LFHI, acoustic imaging, electrolocation imaging and noisy particle imaging techniques and materials which can be used to determine placement of proppants in complex fracture networks during and after a fracture treatment, such as during closure on glass beads or other proppants, as one non-limiting example. The ability to image proppant distribution will allow evaluation of the importance of proppant size for placement within narrow fractures and complex fracture network regions in the treated intervals. With the use of diagnostic lateral wellbores improved fracture imaging technology can evaluate conventional and new proppant suspension agents. Suspension agents are used to help prevent or inhibit proppant sedimentation and settling prior to fracture closure. In a non-limiting example, one or more diagnostic lateral wellbore may be used to acquire an image of a particular fracture network at initial distribution and then during and/or after sedimentation of the proppant. Structural, compositional, and/or concentration changes can then be made to the anti-settling agent, density of the proppant, and the like, and continued evaluation of product performance may be made using information generated by the proppant imaging capability. Indeed, many types of conventional and future technologies may be evaluated under field conditions by operators using at least one diagnostic lateral wellbore adjacent to at least one primary lateral wellbore and/or another diagnostic lateral wellbore. That is, there have been major limitations in the ability to accurately, comprehensively and geometrically evaluate the performance of new technology. The ability to differentiate the effectiveness of one technology from another is of significant economic importance for developing and advancing technology for shale completions in the future.

For example, in a four interval series of hydraulic frac treatments where electrolocation devices are placed perpendicularly to the diagnostic lateral wellbore and in the middle of each fracture interval, by using the same frac treatment design and only varying the size and amount of conductive-material coated proppant used in each interval, such as 2 ppa of 30/70 mesh (595/210 microns) proppant in the first interval (i.e. pounds of proppant added to each one gallon volume of treatment fluid), 2 ppa of 150 mesh (112 microns) in the second interval, 4 ppa of 200 mesh (74 microns) in the third interval, and 4 ppa of 1.1 specific gravity 200 mesh proppant material in the fourth interval, measurement of electrolocation signals from each of the zones during and after the frac treatments can be performed to see how proppant size-fracture width influence proppant distribution. The proppant distribution tests will also provide criteria about proppant setting within various fracture widths. Additional evaluation tests could be performed with and without proppant “anti-settling agents” for more accurate determination of performance of these agents. The abbreviation “ppa” refers to pounds of proppant added to one gallon of fluid volume.

FIG. 1 presents a schematic, top, plan view of a first primary lateral wellbore 42 and diagnostic lateral wellbore 46 extending from the same vertical wellbore 40 (seen in section, on end) with non-limiting illustration of parallel configuration sections at distance from each other, that is, offset from one another. Coiled tubing 44 and 48 is present within first primary lateral wellbore 42 and diagnostic lateral wellbore 46, respectively. It will be appreciated that coiled tubing 44 and 48 do not extend the lengths of first primary lateral wellbore 42 and diagnostic lateral wellbore 46, respectively. Further illustrated are five frac intervals shown for each parallel lateral wellbore section, intervals 1 through 5. The direction of the injection through is indicated by arrow 50 through first primary lateral wellbore 42. Diagnostic injection tests are performed at each of the five frac interval for learning at least one or more parameter(s) about hydraulic fracture treatment interaction with geo-specific shale reservoir 52, including but not limited to, fracture hit time tests (schematically illustrated by arrows 54) for determining the fracture complexity storage modulus, that is, the fracture hit times 54 being the pump time and treatment fluid volume pumped from perforations or injection points 56 (or the like) from first primary lateral wellbore 42 to perforations or pressure sensors 58 at diagnostic lateral wellbore 46, for the time and volume required when pressure is first indicated, and the fracture complexity storage modulus being the total treatment volume ratio to a frac model calculated planar fracture volume between the primary lateral wellbore 42 and diagnostic lateral wellbore 46.

The diagnostic injection test for each frac interval 1, 2, 3, 4, and 5 can consist of one or multiple injection tests besides fracture hit time tests 54, that is, injection tests with different treatment fluids, with and without a chemical diverter, at different injection rates, at different treatment and/or stage volumes, with different sizes and densities of proppant, with or without tracer materials, and the like, as non-limiting examples. In particular, for each interval 1-5, there may be determined an upstream pressure Pᵤ and a downstream pressure P_{d1}, for each of the first primary lateral wellbore 42 and the diagnostic lateral wellbore 46. Referring to FIG. 27A of U.S. Patent Application Publication No. 2016/0326859 A1 and primary lateral wellbore 403 and optionally stepped parallel diagnostic lateral wellbore 404, diagnostic tests performed at different lateral distances (i.e. 50 feet (15.2 m), 100 feet (30.5 m) and the like) will help generate data specific for amount of fracture complexity near wellbore (such as 0 feet to about 50 feet (15.2 m) as a non-limiting example), for mid-field fracture complexity (such as 50 feet (15.2 m) to about 100 feet (30.5 m) as a non-limiting example), and for far-field fracture complexity generation capability (such as greater than 100 feet (30.5 m) as non-limiting examples). As another non-limiting example, near wellbore fracture complex is from 0 feet to about 40 feet (12.2 m), mid-field fracture complexity is from about 40 feet (12.2 m) to 80 feet (24.4 m), and far-field complex fractures are approximately greater than 80 feet (24.4 m) from the injection lateral. That is, the fracture complexity volume generated in the section at the first 50 feet (15.2 m) distance frac intervals, would be for determining the near-wellbore fracture complexity for the geo-specific shale evaluated, the fracture complexity volume generated in the section at 100 feet (30.5 m) length fracture intervals, would be for determining the approximate mid-field fracture complexity produced, and the fracture complexity volume generated in the section at 150 feet (45.7 m) length fracture intervals, would be for determining the approximate far-field fracture complexity produced. When the resultant difference in hit time and treatment volumes between tests performed on parallel lateral wellbore sections are calculated, the results would allow an understanding of how difficult far-field complex fractures (i.e. hydraulic fracture/natural fracture interaction and dilations, etc.) are to obtain. The amount of far-field fracture complexity can be determined to increase through changes to the set of diagnostic treatment criteria during comparative diagnostic treatments, including injection rate, fluid viscosity, the type and amount and particle size distribution and/or method of using chemical diverters, and the like, as non-limiting examples for performing diagnostic injection tests between lateral wellbores.

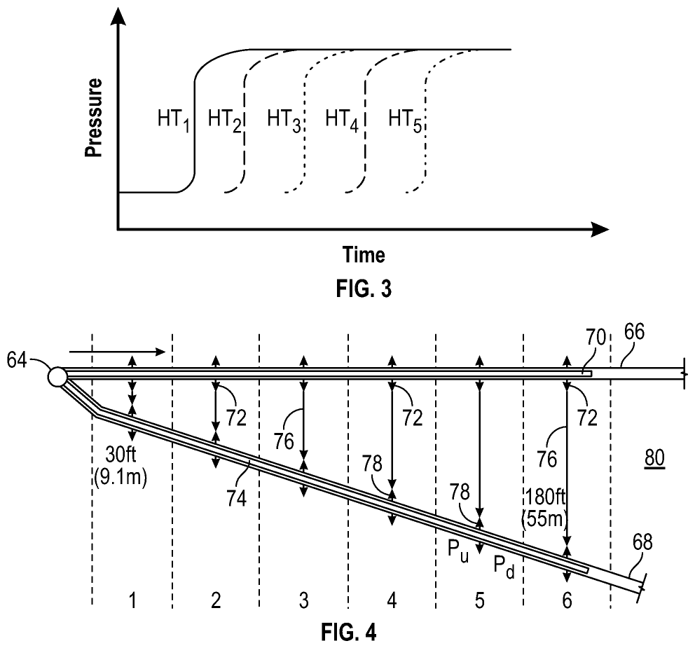

FIG. 2 presents a schematic, top view of an angled diagnostic lateral wellbore section 60 that is angled (non-parallel) to the primary lateral wellbore 42. An angled diagnostic lateral wellbore (or wellbore functioning as a diagnostic wellbore) may be at an angle to the primary lateral wellbore with which it is associated (defined as having at least one signal emitted and/or detected from one to another during an diagnostic injection method described herein) ranging from about 2° independently to about 70°; alternatively from about 5° independently to about 40°. A total of five frac intervals are shown (1-5), in one non-limiting illustration, along the angled diagnostic lateral wellbore 60 having coiled tubing 62 therein. Again, note that coiled tubing 62 does not extend the length of angled diagnostic lateral wellbore 60. For each frac interval 1-5, diagnostic tests are performed for determining the amount of fracture complexity that can be induced for a set of diagnostic fracture treatment criteria, that is, fracture hit time tests 54 can be data-frac tests (injection tests to acquire reservoir-specific treatment data, including empirical based knowledge of what is happening in the reservoir, including upstream pressures Pᵤ and downstream pressures P_{d}, and for determining optimal stimulation engineering parameters) and for determining, understanding, and influencing the hydraulic fracture/natural fracture (i.e. HF/NF) interactions for each geo-specific shale development or field. Fracture hit times HT₁, HT₂, HT₃, HT₄, and HT₅ for the FIG. 2 configuration are plotted as a function of pressure v. time for each interval 1, 2, 3, 4, and 5 as schematically illustrated in FIG. 3.

Complexity (storage modulus) is affected by the nature of the fluid injected, for instance, slickwater versus crosslinked gel (e.g. guar), injection rate, the transportation of the proppant, the type of proppant (e.g. ultra light-weight (ULW) proppant), the performance of a fracture diverter material, and other factors.

As an illustrative non-limiting example of fracture hit time tests 54, injection 50 in primary lateral 42 enters into the reservoir 52 at frac interval 2 of FIG. 1 at perforation 56. Fracture growth can be on each side of primary lateral 42 (i.e. common bi-wing geometry). The planar fracture generated towards diagnostic lateral 46 should be, in most cases, approximately perpendicular to primary lateral 42 and at a given time and injection volume should intersect with diagnostic lateral 46, and thereby increase the pressure of at least one of the pressure sensors 58 which may be within a perforation. At the point of intersection diagnostic lateral wellbore 46 the hydraulic fracture pressure will be picked up (sensor measured) by one or more pressure sensors 58 in the array, and this can be called a fracture hit time 54 during the diagnostic injection test on interval 1 of FIG. 2. The volume amount of treatment fluid in excess to what has been calculated through a frac model for a planar fracture in interval 1 that is in between injection location 56 to pressure detection location 58, will be the inferred volume of complex fracture generated by the HF/NF interactions (fractures that are crossed, sequestered, branched, dilated, extended, sheared, developed, and the like) during the data-frac test, and in the case of interval 1 that has 50 feet (15.2 m) distance (as a non-limiting example) between the primary lateral 42 and diagnostic 46 at interval 1, will be related to the volume amount of the near-wellbore fracture complexity. (Note: The bi-wing planar fracture and related dual-side complex fractures generated from primary lateral wellbore 42 and in between 56 and 58 can be estimated; and more accuracy can be determined by a different data-frac configuration, such as illustrated in non-limiting examples shown in FIG. 6). As a continuing non-limiting example of acquiring empirical data of HF/NF interactions, dilations, branching, growth extension, and the like, a treatment fluid injection test can be performed at frac interval 3 to acquire fracture hit time data, and a third treatment fluid injection test can be performed at injection point 56 of frac interval 5 to acquire the treatment fluid volume and time required for obtaining a pressure hit time 54 on angled diagnostic section 60. Results from fracture hit time and/or pressure hit time 54 produced for frac interval 1, along with fracture hit time 54 for interval 3, in combination and independently can be subtracted from each other and as a net subtracted from the treatment fluid volume for pressure hit time 54 in interval 5, to derive in approximation of the relative near-wellbore fracture complexity, mid-field area fracture complexity, along with determining the relative amount of far-field fracture complexity generated for the given diagnostic treatment inject tests conditions. Other data-frac tests in near-wellbore, mid-field, and far-field wellbore sections can be performed in intervals 5, 3 and 1 of FIG. 2, to further determine the volumetric amounts of HF/NF interactions and resultant distribution of fracture complexity when using different treatment parameters as a method to empirically determine the parameters that influence and/or control the most near-wellbore, mid-field, and far-field generation of fracture complexity for the geo-specific shale reservoir 52.

FIG. 4 presents a schematic, top view of a non-limiting illustration of a coiled tubing configuration, for performing a fracture complexity storage modulus determination test between a primary lateral wellbore 66 connected to vertical wellbore 64 and an angled diagnostic lateral 68 connected to vertical wellbore 64. Shown on primary lateral wellbore 66 are six isolated casing injection points 72, such as sliding sleeves, where coiled tubing 70 (or the like) can be located and the sliding sleeve 72 provides injection isolation, and used with coiled tubing placed isolation packers (or injection tool string assembly; not shown, but see element 421 in FIG. 28C of U.S. Patent Application Publication No. 2016/0326859 A1), for example frac interval 6 targeted injection and diagnostic treatment process configuration. Angled diagnostic lateral 68 contains coiled tubing 74. The diagnostic lateral wellbore 68 is angled from primary lateral wellbore 66 (frac intervals 1 through 6) where the distance between the primary lateral wellbore 66 and angled diagnostic lateral 68 is 30 ft (9.1 m) at interval 1 and 180 ft (55 m) at interval 6. The subterranean shale reservoir is designated at 80.

Also shown, as a non-limiting example, is coiled tubing 70 placed at frac interval 5 on primary wellbore lateral 66, with injection from sliding sleeve 72 with injection tools and/or assembly at reservoir location 72 to create a planar fracture along fracture plane coextensive with hit time 76 towards diagnostic lateral wellbore 68, with a fracture hit time 76 and illustrated complex fracture generated within the frac intervals 1-6, with potential complex fracture pressure hits along pressure directions 76, showing six sections, each with pressure sensors 78 and the like devices, as non-limiting illustrative tool and sensor configuration within frac intervals 1-6.

It is known in the art that when performing a fracture treatment in conventional land reservoirs and typical offshore frac-pack treatments that the execution of a “data-frac” treatment process is performed before the primary frac treatment to induce, generate, and measure treatment and reservoir parameters for fine-tuning the final fracturing treatment design, that is, to understand the proper injection rate, pad volume, number of proppant stages, the concentration of proppant for the proppant stages, and the like from information generated through an injection step-rate test, fracture breakdown pressure, fracture propagation pressure, reservoir closure time after data-frac injection stops, and for fluid efficiency (fluid spurt and Cw leak-off parameters), and the like. Unfortunately, like other conventional fracturing technology, the data-frac criteria to measure and calculate for customizing the frac treatment design has not been transferable, that is, “data-frac treatments” are not typically performed before shale frac treatments because of shale reservoirs nano-darcy permeability and thus the inability to know fracture network closure time; number, size, spacing and the like of complex fractures versus planar fracture growth, (i.e. HF/NF interactions); and the like. FIGS. 1, 2 and 4 herein illustrate configurations and methodologies for performing shale-specific data-fracs, that is, data-frac treatments specific for shale reservoirs to gain and/or measure and calculate information of high importance for the determination of specific stimulation treatment parameters for the specific geographic shale, including but not necessarily limited to: the type of treatment fluids, amount of treatment fluid, fluid injection rate, the size, loading, and total amount of proppant, the effectiveness of chemical diverters, and foremost information on the ability to influence and/or control hydraulic fracture crossing versus dilation interactions with natural fractures and/or weak rockplanes during the fracturing operation. One non-limiting example of executing a shale data-frac is to determine “frac hit times” (schematically illustrated as 54 in FIGS. 1 and 2 and 76 in FIG. 4) by injection from the a specific frac interval location in the primary lateral wellbore and observing pressure increase at and along the data collection and/or diagnostic lateral wellbore configured with isolated pressure sections with pressure sensors. In theory, after determining through known or anticipated reservoir parameters, select frac treatment and/or injection test fluid, pump rate, and the like parameters, with use of known frac models a bi-wing planar fracture treatment fluid volume and anticipated time for the planar fracture may be determined to reach the closest point of the diagnostic lateral wellbore, such as 50 feet (15.2 m) away, in one non-limiting embodiment. For terminology reasons the parameter “reservoir complexity storage modulus” is given as the ratio of fluid volume, where the numerator is the total volume of injection and/or frac fluid pumped and the denominator is the frac model calculated volume of fluid for the planar fracture only to reach the diagnostic lateral wellbore. When storage modulus is zero, there is no fracture complexity. The greater amount of time required, and thereby the greater volume of fluid injected, the bigger the reservoir complexity storage modulus will be. This modulus is in theory the volume of “fracture complexity generated” during the diagnostic data-frac test. Further indirect, inferred and calculated information can be generated, such as number of potential hydraulically induced fractures and/or the average potential width of the non-planar fractures through observation of pressure hits, the relative width or lateral geometry of the potential complex fracture network may be inferred, and the like. Additionally, further injection in the same interval or for the next interval can include tracers of select size particulates, as one non-limiting example, or a chemical diverter as another non-limiting example, and then injected and observed for arrival and/or pressure hits, along the diagnostic lateral wellbore, as well as for fracture hit time changes, and for wider pressure hit distribution along the diagnostic lateral wellbore indicating the diverter improved the hydraulic fracture-natural fracture (and/or weak plane) interaction and complex fracture generation, and the like.

It will be appreciated that although the signal paths between the first primary lateral wellbore and the diagnostic lateral wellbore adjacent thereto, which are coextensive with the hit times 54 (FIGS. 1 and 2), hit times 76 (FIG. 4), and hit times 92 (FIG. 6), are shown in FIGS. 1, 2, 4, and 6 as being parallel with respect to one another, it is not necessary that the signal paths nor the hit times be parallel, although they may be.

The method herein may use fracturing models to calculate the volume of a planar fracture (for instance, using slickwater with no lead-off) versus fracture (interval) length. The fracturing models will show the time required to reach (hit) each data collection (diagnostic) lateral. Shorter length interval tests determine volume amounts of near-wellbore complexity generated in the reservoir—the actual pumped fluid volume minus the calculated planar fracture volume=the complexity storage modulus as an alternative definition. Longer length interval tests determine the volume amount of far-field complexity generated in the reservoir (volume relationship of short versus long length interval complexity storage modulus). Engineers can more accurately design factory frac treatment designs after deriving treatment fluid and diverter induced complexity storage modulus data.

It will be appreciated that the methods described herein may also be used to fine tune diverter design in fracturing subterranean formations to induce fracture complexity. For instance, when fracturing a subterranean formation having a plurality of intervals in sequence along a first primary lateral wellbore and at least one diagnostic lateral wellbore adjacent the first primary lateral wellbore, fracture complexity may be induced with a method such as the following:
a) A first interval in the sequence is fractured from the first primary lateral wellbore and an indicator, such as a proppant, is introduced, e.g. with ultra-lightweight proppant (ULWP). In one non-limiting embodiment, the ULWP is a 40-140 mesh (0.4-0.105 mm) tracer-specific ULWP. By “tracer-specific” is meant that the ULWP has a property that can be traced according to known technologies. Fracturing fluid is injected from the first primary lateral wellbore to create fractures.
b) Fracture hit times, pressures, and volumes in the first interval are recorded from the diagnostic lateral in the first interval.
c) Fracture closure in the first interval is induced.
d) Steps a) through c) are repeated for at least one subsequent interval.
e) The amount and size of produced ULWP (or other indicator) is determined to devise a fine-tuned (or simply “tuned”) diverter design for placing a diverter in at least a second interval.
f) The characteristics of a complexity storage modulus for at least the first interval and a third interval on either side of the second interval are determined.
g) The second interval is fractured with the tuned diverter design.
h) A diverter induced change in the complexity storage modulus evaluated and the produced materials from the second interval are analyzed, in either order.
i) From the information obtained in steps h) and i) optimizing the tuned diverter design; and
j) Optionally and subsequently at least a fourth interval is fractured using the tuned diverter design, and in many cases, many subsequent intervals would be fractured this way.
   Optionally, the first primary lateral wellbore and the diagnostic lateral wellbore each contain coiled tubing, as described elsewhere herein.

Correlations and analytical techniques are known in the art which can supplement or contribute to devising a fracturing treatment design using the methods herein. H. Gu, et al. in “Hydraulic Fracture Crossing Natural Fracture at Non-orthogonal Angles, A Criterion, Its Validation and Applications,” SPE 139984, SPE Hydraulic Fracturing Technology Conference and Exhibition, The Woodlands, Tex., USA 24-26 Jan. 2011, noted that hydraulic fracturing treatments are an indispensable part of well completion in shale gas field development, and that shale formations often contain natural fractures while complex hydraulic fracture networks may form during a treatment. The complex fracture network is strongly influenced by the interaction between the hydraulic fracture and the pre-existing natural fractures. The authors developed a criterion to determine whether a fracture crosses a frictional interface (pre-existing fracture) at non-orthogonal angles. The dependence of crossing on the intersection angle is shown quantitatively using the extended criterion. The fracture is more likely to turn and propagate along the interface than to cross it when the angle is less than 90°. The authors described and discussed validation of the criterion using laboratory experiments for various angles. When applied to laboratory experiments, good agreement was observed between the criterion and experiments for a wide range of angles. The criterion can be used to determine whether hydraulic fractures cross natural fractures under particular field conditions, and it has been incorporated in a hydraulic fracture model that simulates hydraulic fracture propagation in a natural fractured formation.

There are also X. Weng, et al. who in “Modeling of Hydraulic Fracture Network Propagation in a Naturally Fractured Formation,” SPE 140253, SPE Hydraulic Fracturing Technology Conference and Exhibition, The Woodlands, Tex., USA 24-26 Jan. 2011, noted that hydraulic fracturing in shale gas reservoirs has often resulted in complex fracture network growth, as evidenced by microseismic monitoring. They note that the nature and degree of fracture complexity must be clearly understood to optimize stimulation design and completion strategy. Unfortunately, the existing single planar fracture models used in the industry today are not able to simulate complex fracture networks. A new hydraulic fracture model was developed by them to simulate complex fracture network propagation in a formation with preexisting natural fractures. The model solves a system of equations governing fracture deformation, height growth, fluid flow, and proppant transport in a complex fracture network with multiple propagating fracture tips. The interaction between a hydraulic fracture and pre-existing natural fractures is taken into account by using an analytical crossing model and is validated against experimental data. The model is able to predict whether a hydraulic fracture front crosses or is arrested by a natural fracture it encounters, which leads to complexity. It also considers the mechanical interaction among the adjacent fractures (i.e., the “stress shadow” effect). An efficient numerical scheme is used in the model so it can simulate the complex problem in a relatively short computation time to allow for day-to-day engineering design use. Simulation results from the new complex fracture model show that stress anisotropy, natural fractures, and interfacial friction play critical roles in creating fracture network complexity. Decreasing stress anisotropy or interfacial friction can change the induced fracture geometry from a bi-wing fracture to a complex fracture network for the same initial natural fractures. The results presented illustrate the importance of rock fabrics and stresses on fracture complexity in unconventional reservoirs. They have major implications on matching microseismic observations and improving fracture stimulation design.

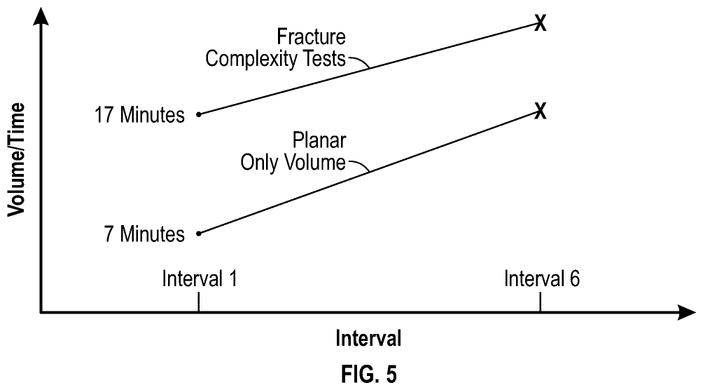

FIG. 5 shows the test results of the scenario presented in FIG. 4. There are six intervals with different distances from injection primary lateral wellbore 66 to the diagnostic lateral wellbore 68 being measured. Thus, the X axis represents the distance from the injection wellbore, which increases from Interval 1 to Interval 6. The Y Axis represents the volume or time the created fractures reach the monitoring or diagnostic lateral, which is indicated by pressure jump (see for instance FIG. 3). The lower line that is labeled Planar Only Volume represents the volume or time required for those fractures reach the monitoring/diagnostic lateral when there is no fracture complexity (0 complexity storage modulus at the beginning), while the upper line represents the True volume or time that were taken by those fractures to reach the monitoring/diagnostic lateral. The lower line is calculated by fracturing model. The ratios of these two lines corresponding to each interval result in Table I below, the complexity storage modulus. The second column in Table I refers to the direct ratios of the upper line to the lower line. The third column is how much more volume/time was used comparing to the 0 fracture complexity case.

TABLE 1
Slickwater Data
Complexity Storage Modulus

| | | |
|---|---|---|
| Test 1 | 2.4 | 140% |
| Test 2 | 2.2 | 120% |
| Test 3 | 2.0 | 80% |
| Test 4 | 1.8 | 80% |
| Test 5 | 1.6 | 60% |
| Test 6 | 1.4 | 40% |

FIG. 6 presents a schematic, top plan sectional view of a subsurface volume 90 showing a non-limiting embodiment of a lateral field configuration having intervals 28, 29, 30 and 31. The illustration shows how fracture hit times 92 and related engineering and reservoir information can be acquired by performing diagnostic frac treatments along the angled diagnostic lateral wellbore 86 having coiled tubing 88 therein of lateral wellbore E-B1 from the direction of angled primary lateral wellbore 82 having coiled tubing 84 therein of E-B2, that is, performing data-frac test at intervals 1-6 on E-B1. Note that coiled tubing 84 and 88 only extend to the primary lateral wellbore portion 82 of E-B2 and diagnostic lateral wellbore portion 86 of E-B1, respectively. Lateral wellbores W-A1 through W-A4 and E-A1 through E-A4 extend from vertical wellbore A (seen on-end from above); lateral wellbores W-B1 through W-B4 and E-B1 through E-B4 extend from vertical wellbore B (also seen on-end from above). The eight primary lateral wellbores on the left side of FIG. 6 are denoted “W” for west, and the eight primary lateral wellbores on the right side of FIG. 6 are denoted “E” for east. The eight primary lateral wellbores extending from vertical wellbore A are designated “A”, and the eight primary lateral wellbores extending from vertical wellbore B are designated “B”.) Note how the diagnostic lateral wellbore 86 has six sections 1-6 at six respective distances away from primary lateral wellbore 82 for determining near-wellbore, mid-field, and far-field complexity for rock volume 90. As illustrated, fracture hit time tests 1-6 would have increasingly longer distances within reservoir area 90 to travel before hydraulic planar and/or complex fractures from primary lateral wellbore 82 intersect the diagnostic lateral wellbore 86; and where data-frac test 6 has the farthest distance within reservoir area 90 to travel before intersecting the diagnostic lateral wellbore 86. By utilizing fracture hit time treatments 1-6, with pressure sensors configured along the diagnostic lateral wellbore 86, the time and fluid volume required to travel from primary lateral wellbore 82 of E-B2 to diagnostic lateral wellbore 86 of E-B1 provides empirical data for determining and quantifying how the hydraulic primary fracture which is initiated from primary lateral wellbore E-B1 interacts with natural fractures and/or weak planes in reservoir area 90. If the hydraulic primary fracture does not interact with natural fractures and/or weak planes then the diagnostic fracture hit time will be consistent with what was modeled. However, if additional time and fluid volume is required then “fracture complexity” can be interpreted to have occurred during primary fracture propagation, that is, the primary fracture interacted with and dilated and injected fluid into natural fractures and/or weak planes proportional to the excess or extra time and fluid volume required for the observed actual fracture hit time, when pressure increase was observed by a pressure sensor on diagnostic lateral wellbore 86. Additionally, continued pumping of treatment fluid may further show one or more of the isolated pressure sensors located along the diagnostic lateral wellbore 86 within the related frac interval to increase in pressure and be indicative of fractures that are branched from and that are now distributed within the frac interval when crossing the diagnostic lateral wellbore 86 locale, indicative of fracture complexity distribution in the frac interval. From the initial pressure increase at the diagnostic lateral 86 any additional pressure increase from other isolated adjacent pressure sensors will indicate multiple fractures hitting and crossing the diagnostic lateral 86 at several points, and will infer the type and amount of fracture network complexity that the specific reservoir rock and the specific frac treatment criteria will physically and volumetrically generate.

Up until the discovery described herein the shale industry has not been able to perform data-fracs that would allow it to understand how the reservoir natural fracture network and/or weak planes will respond to select treatment criteria. Utilizing the data-frac methodology disclosed herein the industry may be able to understand and generate treatment designs specific for any particular geo-specific shale lateral field, for instance to inducing fracture complexity along remaining lateral wellbores W-A1 through W-A4, E-A1 through E-A4, W-A1 through W-A4, and E-A1 through E-A4. Past shale lateral field frac treatment design methodology has been conducted only through trial and error execution followed by observation of the production history of the laterals, that is, a slow learning time along with essentially production data-dependent determination for what frac treatment criteria appears to provide the optimum reservoir stimulation and hydrocarbon production for a given lateral field and potential adjacent lateral fields. This trial and error methodology has in some geographic areas taken years for operators to understand the proper or most economically beneficial stimulation treatment designs that give the most apparent complex fracture network and maximized propped area conductivity for optimized hydrocarbon production for that particular lateral field and geographic specific shale characteristics.

Alternatively, multiple injections within the same injection interval may be performed for diagnostic purposes, such as: slickwater initially until multiple pressure hits are observed at the diagnostic lateral wellbore followed by injection of a chemical diverter within the slickwater followed by observation of pressure hit distribution and/or pressure and/or rate changes observed at the measurement locations on the diagnostic lateral wellbore.

In another non-limiting version, such as that shown in FIG. 29c of U.S. Patent Application Publication No. 2016/0326859 A1 shows for a vertical wellbore 400 how two angled diagnostic laterals (406a and 406b respectively) extend from each side of a primary lateral E-A4. By having fracture hit times and treatment fluid volumes data collected from diagnostic laterals on each side of the primary lateral wellbore E-A4, the correlation of information will help contribute to more accuracy and better understanding of the HF/NF interactions specific for geographic shale 490.

FIG. 30a of U.S. Patent Application Publication No. 2016/0326859 A1 presents a schematic, top view of non-limiting illustration of primary lateral wellbore E-B2 connected to vertical wellbore 402 and a second primary lateral wellbore E-B1 that has data collection or diagnostic section 436 comprised of three parallel wellbore sections of different parallel distances from primary lateral wellbore E-B2. Illustrated are frac intervals 1-6, with intervals 1 and 2 along the section of E-B1 closest to E-B2, intervals 3 and 4 at mid-distance from E-B2, and intervals 5 and 6 on the parallel section of E-B1 furthest from E-B2. Shown as 430 is the representative fracture hit times to be generated, and related data and diagnostic treatment processes.

FIG. 31a of U.S. Patent Application Publication No. 2016/0326859 A1 presents a schematic, top view of a non-limiting illustration of bi-well and angled diagnostics bi-laterals data-frac tests configuration. Illustrated are two diagnostic lateral wellbores originating from vertical wellbore 400, and become angled diagnostic laterals 406a and 406b, which are on opposite sides of primary lateral wellbore 409 from independent vertical wellbore 402. A total of twelve frac intervals 422 are shown for performing fracture hit times 430a and 430b.

FIG. 31b of U.S. Patent Application Publication No. 2016/0326859 A1 shows a bi-well and parallel tri-lateral data-frac configuration, where the diagnostic lateral wellbores originate from independent vertical wellbore 400, and become parallel diagnostic lateral wellbores 438a, 438b, and 438c located on one side of primary lateral wellbore 409 that is from independent vertical wellbore 402. A total of twelve frac intervals 422 are listed for twelve diagnostic data-fracs, within this non-limiting example, diagnostic lateral 438a being the parallel wellbore section 50 feet (15.2 m) from the primary lateral, diagnostic lateral 438b being the parallel wellbore section 100 feet from the primary lateral wellbore 409, and diagnostic lateral wellbore 438c being the parallel wellbore section 150 feet (45.7 m) from the primary lateral wellbore 409. In this diagnostic lateral wellbore configuration, each frac interval 422 should provide sequentially for 50 feet, followed by 100 feet (30.5 m), followed by 150 feet (45.7 m) fracture hit time data during the same diagnostic test, such as a data-frac test performed at location 10, with the planar fracture crossing and pressure hitting 438a, 438b and 438c during the injection test.

FIG. 31c U.S. Patent Application Publication No. 2016/0326859 A1 is similar to FIG. 31b therein, but with three additional parallel diagnostics located on the opposite side of primary lateral wellbore 409, for acquiring fracture hit times 430a for pressure sensors on diagnostic lateral wellbores 438a, 438c, and 438c, and where diagnostic pressure hit times 430b are for sensors located on diagnostic lateral wellbores 437a, 437b, and 437c, which respectively are 50 feet (15.2 m), 100 feet (30.5 m) and 150 feet (45.7 m) parallel distance from primary lateral wellbore 409, similar to diagnostic laterals 438a, 438b, and 438c. For each data-frac test the fracture hit times will be acquired at 50 feet (15.2 m), 100 feet (30.5 m), and 150 feet (45.7 m) on both sides of the injection lateral 409, which will provide exceptional diagnostic data, that is, broadening the data and information that can be generated for understanding how to stimulate geo-specific rock volume 490 prior to multi-stage fracturing the lateral field.

Both FIG. 31b and FIG. 31c of U.S. Patent Application Publication No. 2016/0326859 A1 illustrate lateral well configurations for performing diagnostic injection tests with varying treatment parameters for determining how to generate the most near-wellbore, mid-field, and far-field fracture network complexity. For each data-frac test the fracture hit times will be acquired at 50 feet (15.2 m), 100 feet (30.5 m), and 150 feet (45.7 m) on both sides of the injection lateral 409, which will provide exceptional diagnostic data, that is, broadening the data and information towards optimizing the HF/NF interaction for understanding how to best stimulate the geo-specific rock volume 490 prior to, that is, before the numerous frac treatments within the lateral field.

Another non-limiting embodiment is to perform data-frac tests within existing lateral fields, including lateral fields that are near and/or at the end of their economic hydrocarbon production capacity. Since the laterals are already drilled, having vertical wellbores completed, use of at least one existing horizontal lateral with at least one additional drilling of a diagnostic lateral wellbore may be a more economical means to acquire fracture complexity storage modulus data for several economic reasons. Placement of the diagnostic lateral wellbore can be in a non-fraced locale of the field or within areas already fraced, for generation and collection of a range of information. Additionally, for new and older lateral fields, sections of primary and diagnostic laterals can be partially treated, such as eight of sixteen data frac intervals, in one non-limiting example, for determining initial lateral field stimulation treatment design criteria and then for a fracture hit time test at a later time, such as for understanding possible stress changes to the reservoir during a production period, such as for determining engineering and treatment criteria for refrac treatment designs, and the like. That is, the data fracs can be performed at any stage of the well history, and can be staged over a time period for understanding how the reservoirs react initially to stimulation treatment criteria and then also after one or more time periods of reservoir hydrocarbon production. This practice could show limited fracturing initially for some geo-specific shales because later stimulation of sections yet to be fractured may generate, in those sections yet fraced, that more fracture complexity and resultant hydrocarbon production occurs, compared to stimulation of the lateral sections initially and all at once. Much is to still be learned in how to complete and make more economically valuable shale unconventional reservoirs. Later re-injections into prior data-frac treated intervals may also show how over time the hydraulic fracture-natural fracture interactions may change where more fractures are generated, that is, a greater amount of new fractures. It could also be determined if the pressure hits on re-data-fracs give a wider distance of pressure hits along the diagnostic lateral and where the re-data-frac fracture complexity storage modulus showed a substantial increase compared to the initial or first time period data-frac service. Use of data-frac tests may lead to practices such as planning to refrac the same intervals after a time period for generating improved interval fracture geometric complexity and as a method to increase overall production, for instance, injecting from one lateral wellbore to an adjacent diagnostic lateral of relatively close proximity can provide new methods in how to complete and produce lateral fields more economically.

Further, isolated pressure sections can be configured along parallel diagnostic lateral wellbore sections relative to the primary lateral wellbore. In these non-limiting illustrations, the pressure isolation sections may each have a pressure gauge, and the width of each pressure isolation section can be optimized for resolution, such as numerous 20 feet (6.1 m) sections, or only a few 40 feet (12.2 m) sections. Additional non-limiting examples include where fracture hit time intervals with diagnostic laterals close to the primary lateral wellbore may only have two of three isolated pressure sections, and for the fracture hit time intervals that are farthest from the primary lateral wellbore, more than four pressure isolation sections can be optional for collecting data on width of fracture complexity. The evaluation of treatment fluid injection rate, fluid viscosity, and/or sequencing of select volumes of low and high viscosity fluids, addition of a chemical diverter throughout or in stages, addition of select size ultra-light weight proppant to see what may be collected at the select pressure isolation sections, for example to determine fracture width for the fractures crossing the diagnostic lateral wellbore locally, and the like. The type and amount of information can be very important in how to most cost effectively generate the most fracture complexity and conductivity for maximizing reservoir hydrocarbon productivity before lateral field stimulation.

In another non-limiting embodiment, data-fracs can be configured without independent diagnostic lateral wellbores, that is, as illustrated in FIG. 6, the distance between primary laterals, including laterals within a large lateral field, can be intentionally designed during lateral field project development for performing data-fracs. As a non-limiting example, the initial sections of the primary lateral near the vertical wellbore can be configured with spacing and pressure isolation sections and fracture hit time treatment injection for data frac information generation near the vertical wellbore. In another non-limiting example, the primary laterals can be from different vertical wellbores, and where the initial sections or toe sections of each of the adjacent primary laterals are configured for fracture hit time treatments. Additionally, the information generated can be formulated into engineering calculations and computer models for increasing the accuracy and viability of fracture design models for predicting not only the next set of fracture hit time data and observations anticipated, but also for application to the lateral field multi-frac interval fracture treatments, where further calibration of the frac model can be accomplished through integration and/or calibration with the production data, to increase the predictive skill of the computer models on the amount of production results.

Improvements that may be obtained using the diagnostic lateral wellbores include, but are not necessarily limited to, improving the resolution of images of subsurface volumes and features near wellbores particularly micro-images, acquiring and improving information about the stimulation, cleanup, production and refracturing of shale intervals, the character and complexity of hydraulic fracture networks, improving the ability to control fracture closure, improving treatments and processes for fracture treatment fluids, improving fracture network cleanup, and improving production optimization treatments. Techniques of fracturing adjacent wellbores using information obtained from the one or more diagnostic lateral wellbores will help in the distribution of rock stress, treatment pressure, treatment fluids, diversion fluids or agents, clean-up agents, placement of treatment improvement additives, improving far-field propped fracture conductivity, and/or connection of propped primary wellbore fracture extension to far-field fracture networks. The information obtained by the methods and configurations described herein will be important to specify changes in fracture network generation procedures and parameters based on how a specific shale formation behaves and fractures under certain conditions. This will result in increased treatment efficiency to produce greater fracture complexity and fracture conductivity to maximize hydrocarbon production and total hydrocarbon recovery. The methods and configurations described herein will significantly improve the speed and accuracy of using wildcat wells to locate shale sweet-spots in new geologic or geologic or geo-specific shale plays. Useful imaging diagnostic imaging techniques include, but are not necessarily limited to electrolocation, electromagnetic methods, noisy particles, and the like. Combination with known diagnostic tools and measurement devices, such as DTS, DAS, microseismic, wellbore logging, and the like can improve the amount and accuracy of knowledge gained during practice of the disclosed methods and configurations.

In the foregoing specification, the invention has been described with reference to specific embodiments thereof, and has been demonstrated as effective in providing configurations, methods, and compositions for improving the information about, data about, and parameters of subterranean formations that have been and/or will be hydraulically fractured. However, it will be evident that various modifications and changes can be made thereto without departing from the broader scope of the invention as set forth in the appended claims. Accordingly, the specification is to be regarded in an illustrative rather than a restrictive sense. For example, the number and kind of primary and/or diagnostic lateral wellbores, configurations of these wellbores, diagnostic devices, fracturing, cleanup and treatment procedures, specific fracturing fluids, particular diagnostic fluids, cleanup fluids and gases, treatment fluids, fluid compositions, viscosifying agents, proppants, proppant suspending agents, diverting materials, and other components falling within the claimed parameters, but not specifically identified or tried in a particular composition or method, are expected to be within the scope of this invention. Further, it is expected that the primary and lateral assisting wellbores and procedures for fracturing, treating and cleaning up fracture networks may change somewhat from one application to another and still accomplish the stated purposes and goals of the methods described herein. For example, the methods may use different wellbore configurations, components, fluids, wellbores, component combinations, diagnostic devices, different fluid and component proportions, data-frac parameters used, data-frac variables investigated, empirical data generated specific for fracturing software development, and additional or different steps than those described and exemplified herein.

The present invention may suitably comprise, consist or consist essentially of the elements disclosed and may be practiced in the absence of an element not disclosed. For instance, there may be provided a method for evaluating and optimizing fracture complexity when fracturing a subterranean formation having a plurality of intervals in a sequence along a first primary lateral wellbore and at least one diagnostic lateral wellbore adjacent the first primary lateral wellbore, the method comprising, consisting essentially of, or consisting of a) fracturing a first interval in the sequence from the first primary lateral wellbore by injecting fracturing fluid from the first primary lateral wellbore to create fractures, b) recording fracture hit times, pressures and volumes from the diagnostic lateral wellbore in the first interval, c) inducing fracture closure in the first interval, d) repeating steps a) through c) for at least a subsequent interval, and e) devising a fracturing treatment design for the subterranean formation to optimize fracture complexity using the recorded fracture hit times, pressures and volumes.

Alternatively there may be provided a method for evaluating and optimizing fracture complexity when fracturing a subterranean formation having a plurality of intervals in sequence along a first primary lateral wellbore and at least one diagnostic lateral wellbore adjacent the first primary lateral wellbore, where the method comprises, consists essentially of, or consists of a) fracturing a first interval in the sequence from the first primary lateral wellbore with an indicator (optionally an ultra-lightweight proppant (ULWP)) by injecting fracturing fluid from the first primary lateral wellbore in to create fractures, b) recording fracture hit times, pressures, and volumes from the diagnostic lateral wellbore in the first interval, c) inducing fracture closure in the first interval, d) repeating steps a) through c) for at least a subsequent interval, e) determining the amount and size of produced ULWP or other indicator to devise a tuned diverter design for placing a diverter in a second interval, f) determining characteristics of a complexity storage modulus for at least the first interval and a third interval on either side of the second interval, g) fracturing the second interval with the tuned diverter design, h) evaluating a diverter induced change in complexity storage modulus and analyzing produced materials from the second interval, and i) from the information obtained in steps g) and h) optimizing the tuned diverter design.

As used herein, the terms “comprising,” “including,” “containing,” “characterized by,” and grammatical equivalents thereof are inclusive or openended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for evaluating and optimizing fracture complexity when fracturing a subterranean formation having a plurality of intervals in a sequence along a first primary lateral wellbore and at least one diagnostic lateral wellbore adjacent the first primary lateral wellbore, the method comprising:
a) fracturing a first interval in the sequence from the first primary lateral wellbore by injecting fracturing fluid from the first primary lateral wellbore to create fractures;
b) recording fracture hit times, pressures and volumes from the diagnostic lateral wellbore in the first interval;
c) inducing fracture closure in the first interval;
d) repeating steps a) through c) for at least a subsequent interval; and
e) devising a fracturing treatment design for the subterranean formation to optimize fracture complexity for subsequent lateral wellbores using the recorded fracture hit times, pressures and volumes.

2. The method of claim 1 further comprising:
disposing at least one signal generator in the first primary lateral wellbore;
disposing at least one diagnostic device in the at least one diagnostic lateral wellbore;
emitting at least one emitted signal between the at least one signal generator and the at least one diagnostic device;
detecting at least two received signals associated with the at least one emitted signal; and
analyzing the at least two received signals to ascertain complexity of the fracture network of the at least one primary lateral wellbore and/or the subterranean formation.

3. The method of claim 1 where a portion of the first primary lateral wellbore and a portion of the at least one diagnostic lateral wellbore are within about 25 to about 2500 feet (about 7.6 to about 762 meters) of each other.

4. The method of claim 3 where either the first primary lateral wellbore and/or the at least one diagnostic lateral wellbore comprise at least two portions with respect to each other that are at different distances from each other.

5. The method of claim 3 where the first primary lateral wellbore and the at least one diagnostic lateral wellbore comprise respective portions at an angle to each other ranging from about 2° to about 70°.

6. The method of claim 1 where the first primary lateral wellbore and the diagnostic lateral wellbore each contain coiled tubing.

7. The method of claim 1 further comprising optimizing a tuned diverter design from the recorded fracture hit times, pressures and volumes; and subsequently fracturing another portion of the subterranean formation with the optimized tuned diverter design.

8. A method for evaluating and optimizing fracture complexity when fracturing a subterranean formation having a plurality of intervals in a sequence along a first primary lateral wellbore and at least one diagnostic lateral wellbore adjacent the first primary lateral wellbore, the method comprising:
f) fracturing a first interval in the sequence from the first primary lateral wellbore by injecting fracturing fluid from the first primary lateral wellbore to create fractures;
g) recording fracture hit times, pressures and volumes from the diagnostic lateral wellbore in the interval;
h) inducing fracture closure in the first interval;
i) repeating steps a) through c) for at least a subsequent interval; and
j) devising a fracturing treatment design for the subterranean formation to optimize fracture complexity for subsequent lateral wellbores using the recorded fracture hit times, pressures and volumes;
where a portion of the first primary lateral wellbore and a portion of the at least one diagnostic lateral wellbore are within about 25 to about 2500 feet (about 7.6 to about 762 meters) of each other, and where the first primary lateral wellbore and the at least one diagnostic lateral wellbore comprise respective portions at an angle to each other ranging from about 2° to about 70°.

9. The method of claim 8 further comprising:
disposing at least one signal generator in the first primary lateral wellbore;
disposing at least one diagnostic device in the at least one diagnostic lateral wellbore;
emitting at least one emitted signal between the at least one signal generator and the at least one diagnostic device;
detecting at least two received signals associated with the at least one emitted signal; and
analyzing the at least two received signals to ascertain complexity of the fracture network of the at least one primary lateral wellbore and/or the subterranean formation.

10. The method of claim 8 further comprising optimizing a tuned diverter design from the recorded fracture hit times, pressures and volumes; and subsequently fracturing another portion of the subterranean formation with the optimized tuned diverter design.

11. A method for evaluating and optimizing fracture complexity when fracturing a subterranean formation having a plurality of intervals in a sequence along a first primary lateral wellbore and at least one diagnostic lateral wellbore adjacent the first primary lateral wellbore, the method comprising:
a) fracturing a first interval in the sequence from the first primary lateral wellbore by injecting fracturing fluid from the first primary lateral wellbore to create fractures;
b) recording fracture hit times, pressures and volumes from the diagnostic lateral wellbore in the interval;
c) inducing fracture closure in the first interval;
d) repeating steps a) through c) for at least a subsequent interval; and
e) devising a fracturing treatment design for the subterranean formation to optimize fracture complexity for subsequent lateral wellbores using the recorded fracture hit times, pressures and volumes.
where either the first primary lateral wellbore and/or the at least one diagnostic lateral wellbore comprise at least two portions with respect to each other that are at different distances from each other; the method further comprising:
disposing at least one signal generator in the first primary lateral wellbore;
disposing at least one diagnostic device in the at least one diagnostic lateral wellbore;
emitting at least one emitted signal between the at least one signal generator and the at least one diagnostic device;
detecting at least two received signals associated with the at least one emitted signal; and
analyzing the at least two received signals to ascertain complexity of the fracture network of the at least one primary lateral wellbore and/or the subterranean formation.

12. The method of claim 11 where a portion of the first primary lateral wellbore and a portion of the at least one diagnostic lateral wellbore are within about 25 to about 2500 feet (about 7.6 to about 762 meters) of each other.

13. The method of claim 11 where the first primary lateral wellbore and the at least one diagnostic lateral wellbore comprise respective portions at an angle to each other ranging from about 2° to about 70°.
